(19) United States
(12) Patent Application Publication
(10) Pub. No.: US 2026/0135968 A1
(43) Pub. Date: May 14, 2026

(54) RECEIVING DEVICE, ELECTRONIC DEVICE AND SYSTEM HAVING THE SAME

(71) Applicant: Samsung Display Co., LTD., Yongin-si (KR)

(72) Inventor: Jong Woon KIM, Yongin-si (KR)

(21) Appl. No.: 19/353,346

(22) Filed: Oct. 8, 2025

(30) Foreign Application Priority Data
Nov. 12, 2024 (KR) 10-2024-0160455

(51) Int. Cl. H04N 5/52

(52) U.S. Cl. CPC H04N 5/52

(57) ABSTRACT

A receiving device includes: an equalizer to receive a data signal from a transmitting device over a channel, and apply a gain value to a frequency range component of the data signal; and a control unit to determine the gain value based on temperature information, and generate a gain control signal for controlling the equalizer to apply the gain value.

### CROSS-REFERENCE TO RELATED APPLICATION

The present application claims priority to and the benefit of Korean Patent Application Number 10-2024-0160455, filed on Nov. 12, 2024, in the Korean Intellectual Property Office, the entire disclosure of which is incorporated by reference herein.

### BACKGROUND

### 1. Field

Aspects of embodiments of the present disclosure relate to a receiving device, an electronic device including the receiving device, and a system including the receiving device.

### 2. Description of the Related Art

A main link may be provided between a source device for generating an image signal and a sink device for realizing an image from the image signal of the source device. The image signal may be transmitted via the main link. Further, an auxiliary channel may be provided between the source device and the sink device. Auxiliary data, such as configuration information of the source device or the sink device, may be transmitted via the auxiliary channel.

The above information disclosed in this Background section is for enhancement of understanding of the background of the present disclosure, and therefore, it may contain information that does not constitute prior art.

### SUMMARY

Embodiments of the present disclosure may be directed to a receiving device capable of optimally setting a gain value of an equalizer in response to temperature variations, an electronic device including the receiving device, and a system including the receiving device.

According to one or more embodiments of the present disclosure, a receiving device includes: an equalizer configured to receive a data signal from a transmitting device over a channel, and apply a gain value to a frequency range component of the data signal; and a control unit configured to determine the gain value based on temperature information, and generate a gain control signal for controlling the equalizer to apply the gain value.

In an embodiment, the receiving device may further include a temperature sensor configured to sense a temperature, and generate the temperature information.

In an embodiment, the control unit may include: a temperature sensor configured to sense a temperature, and generate the temperature information; a lookup table storage configured to store a gain lookup table including a plurality of gain values corresponding to different temperatures; and a gain determiner configured to generate the gain control signal for controlling the equalizer to apply the gain value corresponding to the temperature information with reference to the gain lookup table.

In an embodiment, the gain lookup table may include the plurality of gain values corresponding to different temperature ranges, and the gain determiner may be configured to control the equalizer to apply the gain value corresponding to a temperature range including a temperature indicated by the temperature information.

In an embodiment, the channel may include a plurality of lanes, the gain lookup table may include a plurality of gain values corresponding to different temperature ranges for each of the plurality of lanes, and the gain determiner may be configured to generate the gain control signal for controlling the equalizer to apply the gain values corresponding to a temperature range including a temperature indicated by the temperature information with respect to each of the plurality of lanes.

In an embodiment, the gain lookup table may include a plurality of gain values corresponding to different reference temperatures, respectively, and the gain determiner may be configured to calculate a gain value corresponding to a temperature indicated by the temperature information by interpolating the plurality of gain values corresponding to the different reference temperatures, respectively, and generate the gain control signal for controlling the equalizer to apply the gain value.

In an embodiment, the gain determiner may be configured to calculate the gain value using a linear interpolation.

In an embodiment, the channel may include a plurality of lanes, the gain lookup table may include a plurality of gain values corresponding to different reference temperatures, respectively, with respect to each of the plurality of lanes, and the gain determiner may be configured to calculate the gain values corresponding to a temperature indicated by the temperature information by interpolating the plurality of gain values corresponding to the different reference temperatures with respect to each of the plurality of lanes, and generate the gain control signal for controlling the equalizer to apply the gain values corresponding to the temperature to each of the plurality of lanes.

In an embodiment, the receiving device may be configured to receive the temperature information from the transmitting device through an auxiliary channel.

In an embodiment, the control unit may include: a lookup table storage configured to store a gain lookup table including a plurality of gain values corresponding to different temperatures; and a gain determiner configured to generate the gain control signal for controlling the equalizer to apply the gain value corresponding to the temperature information with reference to the gain lookup table.

In an embodiment, the control unit may be configured to determine the gain value based on the temperature information after the receiving device is connected to the transmitting device over the channel.

In an embodiment, the receiving device may further include a monitoring unit configured to monitor whether or not a symbol error occurs in data, and the control unit may be configured to determine the gain value based on the temperature information after the symbol error occurs.

According to one or more embodiments of the present disclosure, a system includes: a transmitting device configured to output a data signal to a channel comprising a plurality of lanes; and a receiving device configured to receive the data signal from the channel. The receiving device includes: an equalizer configured to apply a gain value to a frequency range component of the data signal; and a control unit configured to determine the gain value based on temperature information, and generate a gain control signal for controlling the equalizer to apply the gain value.

In an embodiment, the control unit may include: a temperature sensor configured to sense a temperature, and generate the temperature information; a lookup table storage configured to store a gain lookup table including a plurality of gain values corresponding to different temperatures; and a gain determiner configured to generate the gain control signal for controlling the equalizer to apply the gain value corresponding to the temperature information with reference to the gain lookup table.

In an embodiment, the transmitting device may further include a temperature sensor configured to sense a temperature, and generate the temperature information.

In an embodiment, the system may further include an auxiliary channel connected between the receiving device and the transmitting device, and configured to transmit the temperature information to the receiving device.

In an embodiment, the control unit may include: a lookup table storage configured to store a gain lookup table including a plurality of gain values corresponding to different temperatures; and a gain determiner configured to generate the gain control signal for controlling the equalizer to apply the gain value corresponding to the temperature information with reference to the gain lookup table.

In an embodiment, the control unit may be configured to determine the gain value based on the temperature information after the receiving device is connected to the transmitting device over the channel.

In an embodiment, the receiving device may further include a monitoring unit configured to monitor whether or not a symbol error occurs in data, and the control unit may be configured to determine the gain value based on the temperature information after the symbol error occurs.

According to one or more embodiments of the present disclosure, an electronic device includes: a processor; a receiving device configured to receive image data; and an electronic device including a display device including pixels, and configured to display an image on the pixels based on the image data in response to a control of the processor. The receiving device includes: an equalizer configured to receive a data signal from a transmitting device over a channel, and apply a gain value to a frequency range component of the data signal; and a control unit configured to determine the gain value based on temperature information, and generate a gain control signal for controlling the equalizer to apply the gain value.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a diagram illustrating a configuration of a link that mediates a signal transmission between a display source and a display sink.

FIG. 2 is a block diagram illustrating an example of a display source and a display sink as shown in FIG. 1.

FIG. 3 is a block diagram illustrating a control unit of FIG. 2 according to an embodiment.

FIG. 4 is a block diagram illustrating an example of a display source and a display sink as shown in FIG. 1.

FIG. 5 is a block diagram illustrating a control unit of FIG. 4 according to an embodiment.

FIG. 6 is a flowchart illustrating a method of operating a receiving device according to an embodiment of the present disclosure.

FIG. 7 is a flowchart illustrating a process of the method of FIG. 6 according to an embodiment.

FIG. 8 is a block diagram illustrating an electronic device including the display sink of FIG. 1 according to an embodiment.

FIG. 9 is a perspective view of an example of a smartphone implemented as the electronic device of FIG. 8.

FIG. 10 is a perspective view of an example of a tablet computer implemented as the electronic device of FIG. 8.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

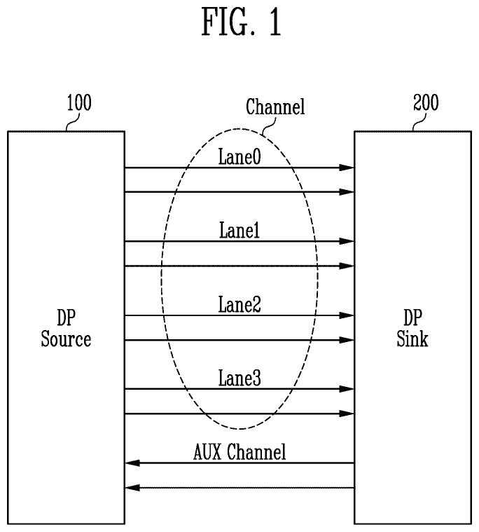

FIG. 1 is a diagram illustrating a configuration of a link that mediates a signal transmission between a display source 100 and a display sink 200.

Referring to FIG. 1, a display port system may include the display source 100 and the display sink 200, which are connected to each other via an optical link to transmit and receive main and auxiliary data with each other.

The display source 100 may include any suitable kind of device that generates and transmits a signal. For example, the display source 100 may be provided as a variety of suitable electronic devices, such as a television, a computer, a DVD player, a cellular phone, a smartphone, a PDA, a notebook PC, a tablet PC, an e-book, an electronic picture frame, a kiosk, a Blu-ray disc, a set-top box, and the like.

The display sink 200 may include any suitable kinds of devices that receive a signal from the display source 100, and play the signal back. For example, the display sink 200 may be provided as a variety of suitable electronic devices having a display, such as a TV, a computer, a DVD player, a cell phone, a smartphone, a PDA, a notebook PC, a tablet PC, an e-book, an electronic picture frame, a kiosk, and the like.

Data may be transmitted over a channel connected between the display source 100 and the display sink 200. The channel may include a plurality of lanes Lane0 to Lane3, and may be referred to as a main link. Video signals (or image signals) and audio signals may be transmitted over the channel, for example, over the main link. In addition, control signals, such as horizontal synchronization signals and vertical synchronization signals, may also be transmitted over the channel. As an example, the display source 100 may process video signals (or image signals) and audio signals into packets, and may distribute the packets to the main lanes Lane0 to Lane3, which constitute the channel.

An auxiliary (AUX) channel may be connected between the display source 100 and the display sink 200 for transmission of auxiliary data for setting up or managing the channel. The display source 100 may output auxiliary data of a single ended signal, which is input from a graphics control unit (e.g., a graphics controller) or another control configuration (e.g., another controller) other than the graphics control unit, as a differential signal. In addition, the display source 100 may receive as the auxiliary data, a differential signal transmitted via the AUX channel. In other words, unlike the channel, the AUX channel may transmit auxiliary data in both directions between the display source 100 and the display sink 200, so that the display source 100 and the display sink 200 connected to the AUX channel may each function as a transmitting side or a receiving side. For example, the auxiliary channel may transmit auxiliary data in both directions in a half duplex manner. In an embodiment, the AUX channel may communicate using a differential signal rather than an Inter Integrated Circuit (I2C) method.

The channel including the lanes Lane0 to Lane3 may transmit data unidirectionally between the display source 100 and the display sink 200. In other words, the channel may transmit data unidirectionally from the display source 100 toward the display sink 200. Accordingly, the display source 100 and the display sink 200 connected to the channel may function as a transmitting side and a receiving side, respectively.

In an embodiment of the present disclosure, the display source 100 and the display sink 200 connected to the AUX channel may have the same or substantially the same (or similar) configurations as each other, because the display source 100 and the display sink 200 may each function as a transmitting side to transmit auxiliary data and a receiving side to receive auxiliary data.

In some embodiments, the display port system may further include a hot plug detection (HPD) line to support a hot plug functionality, in addition to the channel (e.g., the lanes Lane0 to Lane3) and the AUX channel.

As used herein, the display source 100 may be referred to as a transmitting device, and the display sink 200 may be referred to as a receiving device. In other words, in addition to the display port system that transmits image signals (e.g., picture signals) and audio signals (e.g., sound signals), some embodiments of the present disclosure may be applicable to a port system that transmits and receives various other data signals.

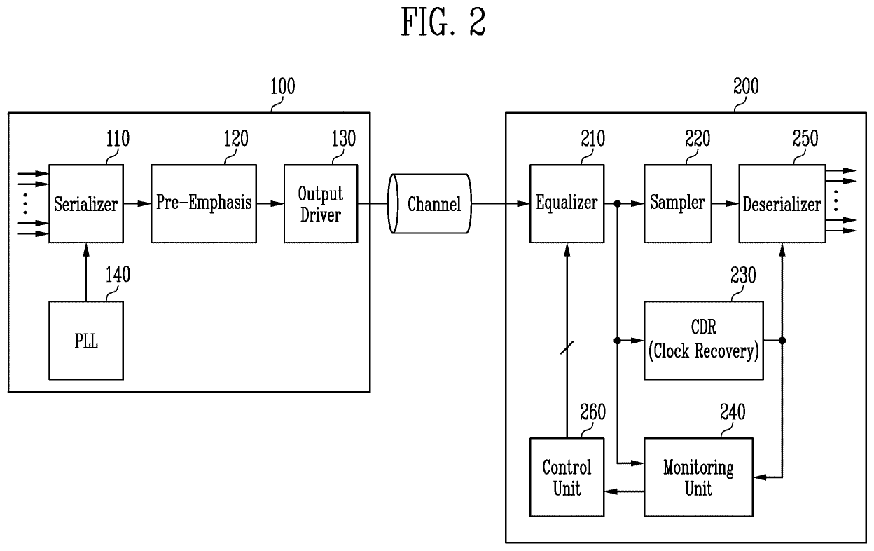

FIG. 2 is a block diagram illustrating an example of the display source 100 and the display sink 200 as shown in FIG. 1. In FIG. 2, the auxiliary channel (AUX channel) is omitted for convenience of illustration.

Referring to FIG. 2, the display source 100 may include a serializer 110, a pre-emphasis circuit 120, an output driver 130, and a phase-locked loop (PLL) circuit 140.

The serializer 110 may convert a data signal received in parallel form into a time-ordered data signal in serial form. The pre-emphasis circuit 120 may emphasize a frequency band (e.g., a predetermined frequency band) of the data signal in serial form received from the serializer 301. The pre-emphasis circuit 120 may improve a signal-to-noise ratio (S/N), frequency characteristics, and distortion characteristics. The output driver 130 may transmit the data signal with the emphasized frequency band received from the pre-emphasis circuit 120 to the display sink 200 over the channel. The phase-locked loop circuit 140 may be a frequency negative feedback circuit to keep the frequency of the output signal constant or substantially constant at all times. In more detail, the phase-locked loop circuit 140 may detect a phase difference between the input signal and the output signal, and may output a constant or substantially constant frequency signal by controlling a voltage controlled oscillator.

The display sink 200 may include an equalizer 210, a sampler 220, a clock recovery circuit (CDR) 230, a monitoring unit (e.g., a monitoring circuit) 240, a deserializer 250, and a control unit (e.g., a controller) 260.

The equalizer 210 may evenly adjust the frequency characteristics of the received data signal to a desired range. As an example, the equalizer 210 may apply different gains depending on the frequencies to reduce the magnitude of low-frequency components relative to high-frequency components. The equalizer 210 may operate similarly to a high-pass filter that passes signal components in the high-frequency range, and applies a low gain to signal components in the low-frequency range. The sampler 220 may sample the data signal received from the equalizer 210 as many times as necessary. The clock recovery circuit 230 may generate a normal clock signal using the data signal received from the equalizer 210. The monitoring unit 240 receives the data signal received from the equalizer 210, and receives a plurality of clock signals from the clock recovery circuit 230. The plurality of clock signals may include a normal clock signal. The monitoring unit 240 may measure at least one of a phase, an amplitude, a rising time, or a falling time of the received data signal. The monitoring unit 240 may detect a symbol error in the data signal, and may deliver a signal corresponding to the detection result to the control unit 260. The deserializer 250 may convert the received data signal in serial form into a signal in parallel form. The control unit 260 generates a feedback signal based on the information measured by the monitoring unit 240. In more detail, the control unit 260 may transmit a gain control signal to the equalizer 211 for adjusting the gain to be applied to a particular frequency band of the data signal when a symbol error occurs.

In more detail, the equalizer 210 may change the gain applied to a particular band (e.g., a low frequency band or a high frequency band) of a received data signal based on the feedback signal received from the control unit 260. In an embodiment, the feedback signal may include information indicating whether a symbol error occurs or not. Accordingly, the equalizer 210 may compensate for a signal distortion that may occur as the data signal is transmitted from the display source 100 to the display sink 200 over the channel (e.g., a distortion of high frequency components or low frequency components).

According to an embodiment of the present disclosure, the display sink 200 may determine a gain used for equalizing the received data based on a temperature. Accordingly, detection errors in data signals transmitted under different temperature conditions may be reduced.

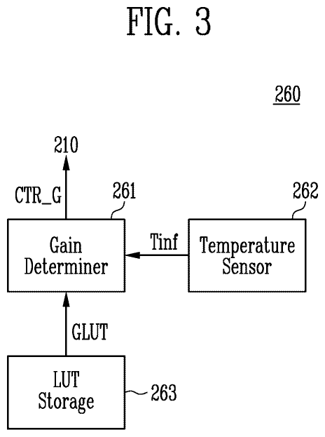

FIG. 3 is a block diagram illustrating the control unit 260 of FIG. 2 according to an embodiment.

Referring to FIG. 3, the control unit 260 included in the display sink 200 (e.g., the receiving device) according to an embodiment of the present disclosure may include a gain determiner 261, a temperature sensor 262, and a lookup table (LUT) storage 263.

The gain determiner 261 may receive temperature information Tinf from the temperature sensor 262, and may receive a gain lookup table GLUT from the lookup table storage 263. A gain value according to each temperature value may be specified in the gain lookup table GLUT. The gain determiner 261 may determine a gain value corresponding to the temperature information Tinf with reference to the lookup table GLUT. The gain determiner 261 may generate a gain control signal CTRL_G corresponding to the determined gain value. The generated gain control signal CTRL_G may be transmitted to the equalizer 210. In response to the received gain control signal CTRL_G, the equalizer 210 may apply the gain value determined by the gain determiner 261 to the received data signal.

The temperature sensor 262 may sense the temperature of the display sink 200, and may generate the temperature information Tinf corresponding to the sensed temperature. The generated temperature information Tinf may be transmitted from the temperature sensor 262 to the gain determiner 261.

The lookup table storage 263 may store the gain lookup table GLUT that includes the gain value corresponding to each temperature range. As an example, the gain lookup table GLUT may be a table as shown in Table 1.

TABLE 1

| Temperature | Gain |
|---|---|
| (T) range | value |
| T < 0° C. | G1 |
| 0° C. ≤ T < 10° C. | G2 |
| 10° C. ≤ T < 20° C. | G3 |
| 20° C. ≤ T < 30° C. | G4 |
| 30° C. ≤ T < 40° C. | G5 |
| T ≥ 40° C. | G6 |

For example, referring to Table 1, when the temperature indicated by the temperature information Tinf is 18° C., the gain determiner 261 may generate the gain control signal CTRL_G for controlling a value of G3 to be set as the gain, and may transmit the generated gain control signal CTRL_G to the equalizer 210. As another example, when temperature indicated by the temperature information Tinf is 25° C., the gain determiner 261 may generate the gain control signal CTRL_G for controlling a value of G4 to be set to the gain, and may transmit the generated gain control signal CTRL_G to the equalizer 210.

In an embodiment, the gain values determined as shown in Table may be applied in common to the lanes Lane0 to Lane3. However, in some embodiments, the gain values determined based on Table 1 may be applied to lanes that are observed to be significantly affected by the temperature, while a default gain value that is set regardless of the temperature may be applied to the other lanes.

On the other hand, unlike that illustrated in Table 1, different gain values may be applied to the respective lanes depending on the temperature. The gain lookup table GLUT may be a table as shown in Table 2.

TABLE 2

| Temperature | Lane 0 | Lane 1 | Lane 2 | Lane 3 |
|---|---|---|---|---|
| (T) range | gain value | gain value | gain value | gain value |
| T < 0° C. | G1A | G1B | G1C | G1D |
| 0° C. ≤ T < 10° C. | G2A | G2B | G2C | G2D |
| 10° C. ≤ T < 20° C. | G3A | G3B | G3C | G3D |
| 20° C. ≤ T < 30° C. | G4A | G4B | G4C | G4D |
| 30° C. ≤ T < 40° C. | G5A | G5B | G5C | G5D |
| T ≥ 40° C. | G6A | G6B | G6C | G6D |

For example, referring to Table 2, when the temperature indicated by the temperature information Tinf is 18° C., the gain determiner 261 may generate the gain control signal CTRL_G for controlling the values of G3A, G3B, G3C, and G3D to be applied as the gains to the lanes Lane0, Lane1, Lane2, and Lane3, respectively, and may transmit the generated gain control signal CTRL_G to the equalizer 210. As another example, when the temperature information Tinf indicates a temperature of 25° C., the gain determiner 261 may generate the gain control signal CTRL_G for controlling the values of G4A, G4B, G4C, and G4D to be applied as the gains to the lanes Lane0, Lane1, Lane2, and Lane3, respectively, and may transmit the generated gain control signal CTRL_G to the equalizer 210.

Referring to Table 1 and Table 2, the same gain value may be applied for different temperatures in a desired temperature range (e.g., a predetermined temperature range). For example, referring to Table 1, the same gain value is applied when the temperature indicated by the temperature information Tinf is 12° C., 15° C., or 19° C. According to an embodiment of the present disclosure, the gain lookup table GLUT stored in the lookup table storage 263 may include gain values for a plurality of reference temperatures, and the gain determiner 261 may calculate a gain value by interpolation on the temperature between the reference temperatures. For example, the gain lookup table GLUT may be a table as shown in Table 3.

TABLE 3

| | |
|---|---|
| Reference | Gain |
| temperature | value |

| | | |
|---|---|---|
| −30° | C. | GA |
| −15° | C. | GB |
| 0° | C. | GC |
| 15° | C. | GD |
| 30° | C. | GE |
| 45° | C. | GF |

In an embodiment, the gain determiner 261 may calculate a gain value corresponding to a particular temperature through linear interpolation. For example, referring to Table 3, when the temperature information Tinf indicates a temperature of 18° C., the gain determination component 261 may calculate a gain value G_{18° C.} based on Equation 1.

$${G}_{18 ° C} = GD + \frac{GE - GD}{30 - 15} \cdot ( 18 - 15 ) \qquad Equation 1$$

However, the present disclosure is not limited thereto, and the gain determiner 261 may utilize various other suitable methods of interpolation other than the linear interpolation, so as to determine the gain value.

On the other hand, unlike that illustrated in Table 3, different gain values may be applied to the respective lanes depending on the temperature. The gain lookup table GLUT may be a table as shown in Table 4.

TABLE 4

| Reference | | Lane 0 | Lane 1 | Lane 2 | Lane 3 |
|---|---|---|---|---|---|
| temperature | | gain value | gain value | gain value | gain value |
| −30° | C. | GA0 | GA1 | GA2 | GA3 |
| −15° | C. | GB0 | GB1 | GB2 | GB3 |
| 0° | C. | GC0 | GC1 | GC2 | GC3 |
| 15° | C. | GD0 | GD1 | GD2 | GD3 |
| 30° | C. | GEO | GE1 | GE2 | GE3 |
| 45° | C. | GF0 | GF1 | GF2 | GF3 |

Similar to that described above with reference to Table 3 and Equation 1, the gain determiner 261 may calculate a gain value for each lane corresponding to a particular temperature by a linear interpolation.

In FIG. 3, the temperature sensor 262 is illustrated as a component included in the control unit 260. However, the present disclosure is not limited thereto, and the temperature sensor 262 may be provided in the display sink 200 independently of the control unit 260.

Therefore, the receiving device (e.g., the display sink) according to some embodiments of the present disclosure may determine a gain value applied to the equalizer based on the temperature information. Accordingly, detection errors in data signals transmitted under various temperature conditions may be reduced.

In the embodiment illustrated in FIGS. 2 and 3, the temperature information Tinf may be generated by a temperature sensor on the display sink 200. However, the present disclosure is not limited thereto, and the temperature information may also be generated by a temperature sensor on the display source 100.

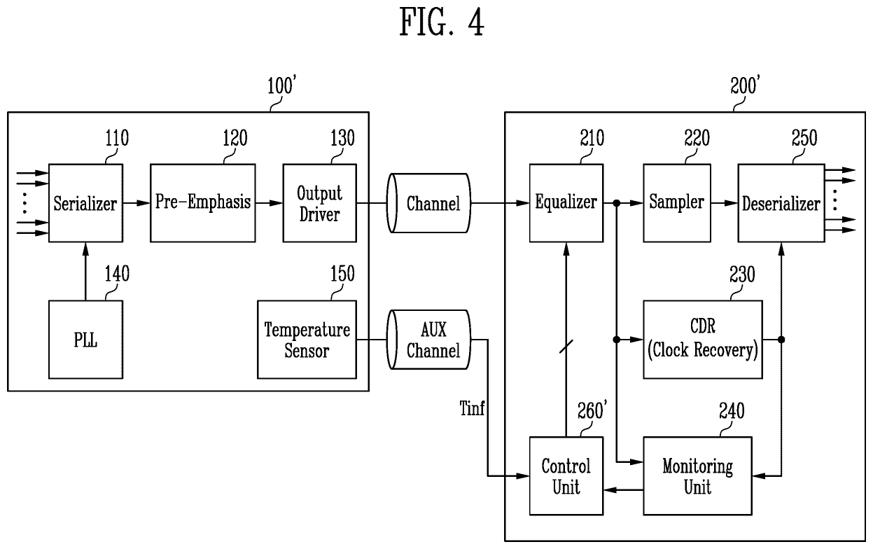

FIG. 4 is a block diagram illustrating an example of the display source and the display sink as shown in FIG. 1. Unlike in FIG. 2, the auxiliary channel (AUX channel) is shown in FIG. 4.

Referring to FIG. 4, a display source 100′ may include the serializer 110, the pre-emphasis circuit 120, the output driver 130, the phase-locked loop (PLL) circuit 140, and the temperature sensor 150. The serializer 110, the pre-emphasis circuit 120, the output driver 130, and the phase-locked loop circuit 140 shown in FIG. 4 may be the same or substantially the same components as those of the serializer 110, the pre-emphasis circuit 120, the output driver 130, and the phase-locked loop circuit 140 described above with reference to FIG. 2, respectively. Accordingly, redundant description thereof may not be repeated.

The temperature sensor 150 included in the display source 100′ may generate the temperature information Tinf, and may transfer the generated temperature information Tinf to a display sink 200′ via the auxiliary channel AUX channel. As described above, the auxiliary channel AUX channel may be provided separately from the channel (e.g., the lanes Lane0 to Lane3) for transmitting the data signal.

The display sink 200′ may include the equalizer 210, the sampler 220, the clock recovery circuit (CDR) 230, the monitoring unit 240, the deserializer 250, and a control unit 260′. The equalizer 210, the sampler 220, the clock recovery circuit 230, the monitoring unit 240, and the deserializer 250 shown in FIG. 4 may be the same or substantially the same components as those of the equalizer 210, the sampler 220, the clock recovery circuit 230, the monitoring unit 240, and the deserializer 250 described above with reference to FIG. 2. Accordingly, redundant description thereof may not be repeated.

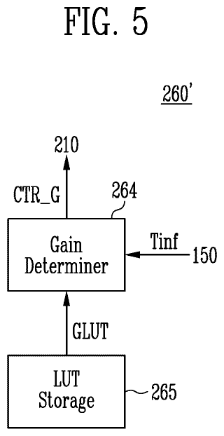

The control unit 260′ of FIG. 4 may receive the temperature information Tinf from the temperature sensor 150 of the display source 100′ via the auxiliary channel AUX channel. The control unit 260′ of FIG. 4 will be described in more detail below with reference to FIG. 5.

FIG. 5 is a block diagram illustrating the control unit 260′ of FIG. 4 according to an embodiment.

Referring to FIG. 5, the control unit 260′ included in the display sink 200′ (e.g., the receiving device) according to another embodiment of the present disclosure may include a gain determiner 264, and a lookup table (LUT) storage 265.

The gain determiner 264 may receive the temperature information Tinf from the temperature sensor 150 of the display source 100, and may receive the gain lookup table GLUT from the lookup table storage 265. A gain value corresponding to each temperature range is specified in the gain lookup table GLUT. The gain determiner 264 may determine a gain value corresponding to the temperature information Tinf with reference to the gain lookup table GLUT. The gain determiner 264 may generate the gain control signal CTRL_G corresponding to the determined gain value. The generated gain control signal CTRL_G may be transmitted to the equalizer 210. In response to the received gain control signal CTRL_G, the equalizer 210 may apply the gain value determined by the gain determiner 264 to the received data signal. The operations of the gain determiner 264 shown in FIG. 5 may be the same or substantially the same as those of the gain determiner 261 described above with reference to FIG. 3.

As such, the receiving device (e.g., the display sink) according to an embodiment of the present disclosure may determine a gain value applied to the equalizer based on the temperature information received from the display source. Accordingly, detection errors of data signals transmitted under various temperature conditions may be reduced.

According to the embodiments described above with reference to FIGS. 2 and 3, the temperature information Tinf may be generated by the temperature sensor on the display sink 200. According to the embodiments described above with reference to FIGS. 4 and 5, the temperature information Tinf may be generated by the temperature sensor on the display source 100. However, the present disclosure is not limited thereto. The temperature information may also be generated by a temperature sensor on the display source 100 and a temperature sensor on the display sink 200. The control unit 260′ may determine a gain value by utilizing both first temperature information generated by the temperature sensor on the display source 100 and second temperature information generated by the temperature sensor on the display sink 200. The lookup table storage included in the control unit may include gain values for various combinations of a temperature range corresponding to the first temperature information and a temperature range corresponding to the second temperature information.

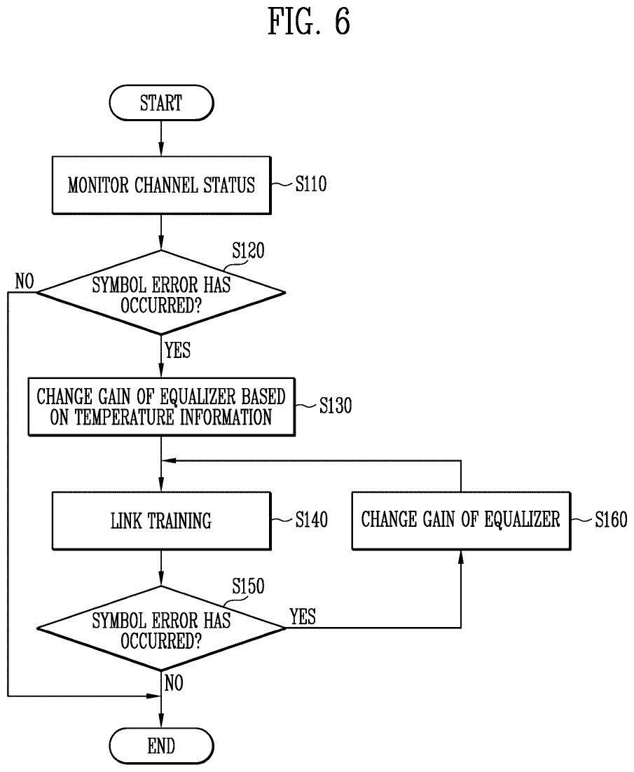

FIG. 6 is a flowchart illustrating a method of operating a receiving device according to an embodiment of the present disclosure.

Referring to FIG. 6, a method of operating a receiving device (e.g., a display sink) according to an embodiment of the present disclosure may start, and a channel status may be monitored (S110). A determination of whether or not a symbol error has occurred in a received data signal may be made (S120). A gain of an equalizer based on temperature information may be changed (S130), and link training may be performed (S140). Whether or not a symbol error has occurred may be re-determined (S150), and the gain of the equalizer may be changed (S160).

In more detail, at S110, the monitoring unit 240 of FIG. 2 or FIG. 4 may monitor a channel status. In other words, the monitoring unit 240 may monitor whether or not a symbol error has occurred as a result of processing a data signal received by the display sink 200, 200′ over the channel at S110.

When no symbol error has occurred (e.g., NO at S120), a gain change operation may end without being performed, and a general operation of receiving a data signal may be performed.

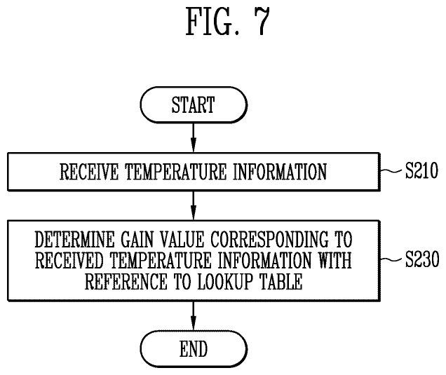

When a symbol error has occurred (e.g., YES at S120), the display sink 200, 200′ may change the gain of the equalizer 210 based on the temperature information Tinf at S130. In more detail, the control unit 260, 260′ of the display sink 200, 200′ may generate the gain control signal CTRL_G to change the gain of the equalizer 210 based on the temperature information Tinf. An embodiment of the process of S130 will be described in more detail below with reference to FIG. 7.

After S130, the display sink 200, 200′ may perform a link training operation at S140. The link training operation may be performed in conjunction with the display source. In more detail, during the link training operation, the display source 100, 100′ may transfer a test pattern to the display sink 200, 200′, and may verify whether or not the test pattern is received well by the display sink 200, 200′.

After performing the link training operation at S140, the display sink 200, 200′ determines whether or not a symbol error has occurred from the test pattern at S150. When the symbol error has not occurred (e.g., NO at S150), a gain change operation may end without being performed, and a general operation of receiving a data signal may be performed.

When a symbol error has occurred (e.g., YES at S150), the display sink 200, 200′ may change the gain of the equalizer at S160. At S130, the gain of the equalizer is changed based on the temperature information, whereas at S160, the gain of the equalizer may be changed in the same or substantially the same manner as that of a comparative link setting method, irrespective of the temperature information. After performing S160, the link training operation is performed again at S140, and whether or not a symbol error has occurred is determined at S150. The processes S140, S150, and S160 may be repeated until no symbol errors occur (e.g., NO at S150), such that the method of FIG. 6 may end.

As shown in FIG. 6, according to the method of operating the receiving device (e.g., the display sink) according to an embodiment of the present disclosure, when a symbol error occurs at S120 after monitoring the channel status at S110, a first equalizer gain change operation at S130 may be performed based on the temperature information. Symbol errors may occur when a data signal is distorted depending on the temperature of a transmission line forming the channel. Therefore, when a symbol error occurs during data transmission, the temperature change may be considered as one of the causes. An efficient gain change operation may be performed by performing the first equalizer gain change based on the temperature information. However, when a symbol error occurs again even after the gain of the equalizer is changed based on the temperature information (e.g., YES at S150), the gain of the equalizer may be changed by another general method that is not based on the temperature information at S160.

FIG. 6 shows an embodiment in which the gain of the equalizer is changed based on the temperature information at S130 when a symbol error occurs at S120 (e.g., YES at S120) as a result of monitoring the channel status at S110. However, the present disclosure is not limited thereto. A gain applied to the equalizer may be initially set based on temperature information immediately after the receiving device (e.g., the display sink) is turned on, or immediately after the receiving device is connected to the transmitting device. The initial gain after the receiving device and the transmitting device are connected to each other via the channel may be set by (e.g., may be determined based on) the temperature information.

FIG. 7 is a flowchart illustrating the process S130 of the method of FIG. 6 according to an embodiment.

Referring to FIG. 7, the process S130 of FIG. 6 may include receiving temperature information (S210), and determining a gain value corresponding to the received temperature information with reference to the lookup table (S230). The processes S210 and S230 of FIG. 7 may be performed substantially by the gain determiner 261, 264 of the control unit 230, 230′ included in the display sink 200.

At S210, the gain determiner 261, 264 may receive the temperature information Tinf. In an embodiment, the gain determiner 261 may receive the temperature information Tinf from the temperature sensor 262 included on the display sink 200. In another embodiment, the gain determiner 264 may receive the temperature information Tinf through the AUX channel from the temperature sensor 262 included on the display source 100.

Subsequently, at S230, the gain determiner 261, 264 may determine a gain value corresponding to the received temperature information Tinf with reference to the gain lookup table GLUT. The gain determiner 261, 264 may determine a gain value corresponding to the received temperature information Tinf in the same or substantially the same manner as that described above with reference to FIG. 3. After performing the process S230, the display sink may apply the determined gain value to the equalizer.

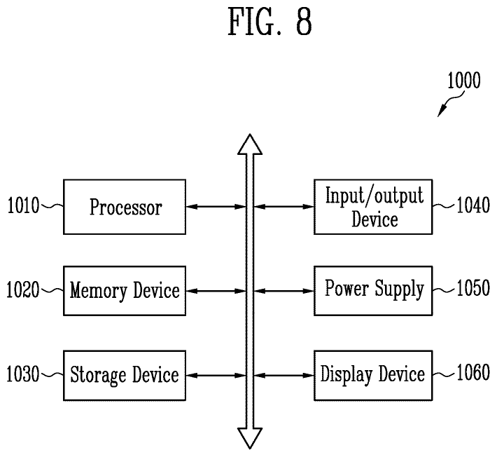

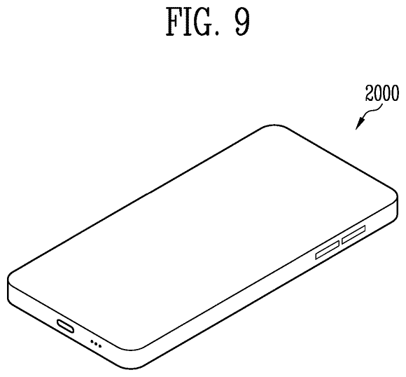

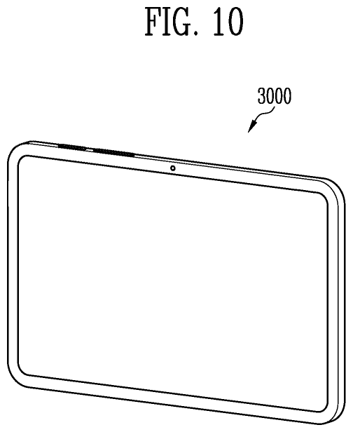

FIG. 8 is a block diagram illustrating an electronic device 1000 including the display sink 200 of FIG. 1 according to an embodiment. FIG. 9 is a perspective view of an example of a smartphone implemented as the electronic device 1000 of FIG. 8. FIG. 10 is a perspective view of an example of a tablet computer implemented as the electronic device 1000 of FIG. 8.

Referring to FIG. 8, the electronic device 1000 may include a processor 1010, a memory device 1020, a storage device 1030, an input/output (I/O) device 1040, a power supply 1050, and a display device 1060.

In some embodiments, as illustrated in FIG. 9, the electronic device 1000 may be a smartphone. In other embodiments, as illustrated in FIG. 10, the electronic device 1000 may be a tablet computer. However, the present disclosure is not limited thereto, and the electronic device 1000 is not necessarily limited to the aforementioned examples. For example, the electronic device 1000 may be a computer device or an electronic device including the display device, such as a Digital Television (TV), a 3D TV, a Personal Computer (PC), home electronic devices, a laptop computer, a mobile phone, a video phone, a smart pad, a smart watch, a head-mounted display device, a personal digital assistant (PDA), a portable multimedia player (PMP), a digital camera, a music player, a portable game console, or a navigation device.

The processor 1010 may perform various suitable calculations or tasks. In some embodiments, the processor 1010 may include an application processor, a graphics processing unit, a microprocessor, or a central processing unit (CPU). The processor 1010 may be connected to the other components through a bus system. In some embodiments, the bus system may include a peripheral component interconnect (PCI) bus. In an embodiment, the processor 1010 may provide the display device 1060 with data streams to be displayed on the display device 1060.

The memory device 1020 may function as a working memory and/or a buffer memory for the electronic device 1000 and/or the processor 1010. In some embodiments, the memory device 1020 may include volatile memory devices, such as a dynamic random access memory (DRAM) device, a static random access memory (SRAM) device, a mobile DRAM device, and the like.

The storage device 1030 may store data in response to a control of the processor 1010. The storage device 1030 may include a non-volatile storage device to retain the data even when the electronic device 1000 is powered off. In some embodiments, the storage device 1030 may include a solid state drive (SSD), a hard disk drive (HDD), a CD-ROM, or the like.

The I/O device 1040 may include various suitable input devices, such as a keyboard, a keypad, a touchpad, a touch screen, and a mouse, and various suitable output devices, such as a speaker and a printer. The I/O device 1040 may include a display port for transmitting or receiving an image signal. As an example, when the electronic device 1000 transmits an image signal, the I/O device 1040 may function as the display source as shown in FIG. 1. As another example, when the electronic device 1000 receives an image signal, the I/O device 1040 may function as the display sink as shown in FIG. 1.

The power supply 1050 may supply power used to perform the operations of the electronic device 1000. For example, the power supply 1050 may include a power management integrated circuit (PMIC). For example, the power supply 1050 may include a battery.

The display device 1060 may display images in response to a control of the processor 1010. The display device 1060 may be connected to the other components through a bus system or other suitable communication links. The display device 1060 may include a plurality of pixels. The display device 1060 may display an image as the respective pixels emit light having different gradations. For example, the display device 1060 displays an image on the pixels based on image data received from the I/O device 1040.

The electronic or electric devices and/or any other relevant devices or components according to embodiments of the present disclosure described herein (e.g., the serializer, the pre-emphasis circuit, the output driver, the phase-locked loop circuit, the equalizer, the sampler, the monitoring unit, the deserializer, the control unit, the clock recovery circuit, the gain determiner, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

According to some embodiments of the present disclosure, in a receiving device, an electronic device including the receiving device, and a system including the receiving device, a gain value of an equalizer may be optimally set (e.g., may be determined) according to temperature variations.

However, the aspects and features of the present disclosure are not limited to those described above, and various other aspects and features will be understood by those having ordinary skill in the art within the spirit and scope of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A receiving device comprising:
an equalizer configured to receive a data signal from a transmitting device over a channel, and apply a gain value to a frequency range component of the data signal; and
a control unit configured to determine the gain value based on temperature information, and generate a gain control signal for controlling the equalizer to apply the gain value.

2. The receiving device of claim 1, further comprising a temperature sensor configured to sense a temperature, and generate the temperature information.

3. The receiving device of claim 1, wherein the control unit comprises:
a temperature sensor configured to sense a temperature, and generate the temperature information;
a lookup table storage configured to store a gain lookup table comprising a plurality of gain values corresponding to different temperatures; and
a gain determiner configured to generate the gain control signal for controlling the equalizer to apply the gain value corresponding to the temperature information with reference to the gain lookup table.

4. The receiving device of claim 3, wherein the gain lookup table comprises the plurality of gain values corresponding to different temperature ranges, and
wherein the gain determiner is configured to control the equalizer to apply the gain value corresponding to a temperature range comprising a temperature indicated by the temperature information.

5. The receiving device of claim 3, wherein the channel comprises a plurality of lanes,
wherein the gain lookup table comprises a plurality of gain values corresponding to different temperature ranges for each of the plurality of lanes, and
wherein the gain determiner is configured to generate the gain control signal for controlling the equalizer to apply the gain values corresponding to a temperature range comprising a temperature indicated by the temperature information with respect to each of the plurality of lanes.

6. The receiving device of claim 3, wherein the gain lookup table comprises a plurality of gain values corresponding to different reference temperatures, respectively, and
wherein the gain determiner is configured to calculate a gain value corresponding to a temperature indicated by the temperature information by interpolating the plurality of gain values corresponding to the different reference temperatures, respectively, and generate the gain control signal for controlling the equalizer to apply the gain value.

7. The receiving device of claim 6, wherein the gain determiner is configured to calculate the gain value using a linear interpolation.

8. The receiving device of claim 3, wherein the channel comprises a plurality of lanes,
wherein the gain lookup table comprises a plurality of gain values corresponding to different reference temperatures, respectively, with respect to each of the plurality of lanes, and
wherein the gain determiner is configured to calculate the gain values corresponding to a temperature indicated by the temperature information by interpolating the plurality of gain values corresponding to the different reference temperatures with respect to each of the plurality of lanes, and generate the gain control signal for controlling the equalizer to apply the gain values corresponding to the temperature to each of the plurality of lanes.

9. The receiving device of claim 1, wherein the receiving device is configured to receive the temperature information from the transmitting device through an auxiliary channel.

10. The receiving device of claim 9, wherein the control unit comprises:
a lookup table storage configured to store a gain lookup table comprising a plurality of gain values corresponding to different temperatures; and
a gain determiner configured to generate the gain control signal for controlling the equalizer to apply the gain value corresponding to the temperature information with reference to the gain lookup table.

11. The receiving device of claim 1, wherein the control unit is configured to determine the gain value based on the temperature information after the receiving device is connected to the transmitting device over the channel.

12. The receiving device of claim 1, further comprising a monitoring unit configured to monitor whether or not a symbol error occurs in data, and
wherein the control unit is configured to determine the gain value based on the temperature information after the symbol error occurs.

13. A system comprising:
a transmitting device configured to output a data signal to a channel comprising a plurality of lanes; and
a receiving device configured to receive the data signal from the channel,
wherein the receiving device comprises:
an equalizer configured to apply a gain value to a frequency range component of the data signal; and
a control unit configured to determine the gain value based on temperature information, and generate a gain control signal for controlling the equalizer to apply the gain value.

14. The system of claim 13, wherein the control unit comprises:
a temperature sensor configured to sense a temperature, and generate the temperature information;
a lookup table storage configured to store a gain lookup table comprising a plurality of gain values corresponding to different temperatures; and
a gain determiner configured to generate the gain control signal for controlling the equalizer to apply the gain value corresponding to the temperature information with reference to the gain lookup table.

15. The system of claim 13, wherein the transmitting device further comprises a temperature sensor configured to sense a temperature, and generate the temperature information.

16. The system of claim 15, further comprising an auxiliary channel connected between the receiving device and the transmitting device, and configured to transmit the temperature information to the receiving device.

17. The system of claim 16, wherein the control unit comprises:
a lookup table storage configured to store a gain lookup table comprising a plurality of gain values corresponding to different temperatures; and
a gain determiner configured to generate the gain control signal for controlling the equalizer to apply the gain value corresponding to the temperature information with reference to the gain lookup table.

18. The system of claim 13, wherein the control unit is configured to determine the gain value based on the temperature information after the receiving device is connected to the transmitting device over the channel.

19. The system of claim 13, wherein the receiving device further comprises a monitoring unit configured to monitor whether or not a symbol error occurs in data, and
wherein the control unit is configured to determine the gain value based on the temperature information after the symbol error occurs.

20. An electronic device comprising:
a processor;
a receiving device configured to receive image data; and
an electronic device comprising a display device comprising pixels, and configured to display an image on the pixels based on the image data in response to a control of the processor,
wherein the receiving device comprises:
an equalizer configured to receive a data signal from a transmitting device over a channel, and apply a gain value to a frequency range component of the data signal; and
a control unit configured to determine the gain value based on temperature information, and generate a gain control signal for controlling the equalizer to apply the gain value.
